(19) United States
(12) Patent Application Publication
(10) Pub. No.: US 2009/0127349 A1
(43) Pub. Date: May 21, 2009

(54) METHOD AND APPARATUS FOR MAINTAINING GUTTERS

(76) Inventor: Nicholas DeLeo, Madison Heights, MI (US)

Correspondence Address: REISING, ETHINGTON, BARNES, KISSELLE, P.C., P O BOX 4390, TROY, MI, 48099-4390, US

(21) Appl. No.: 12/270,648

(22) Filed: Nov. 13, 2008

Related U.S. Application Data
(60) Provisional application No. 60/988,469, filed on Nov. 16, 2007.

(51) Int. Cl. B05B 3/00

(52) U.S. Cl. 239/1; 239/208

(57) ABSTRACT

A method and apparatus for maintaining roof gutters from ground level is provided. The assembly includes an air supply coupled with a first pipe section. A receptacle for holding material to be delivered to the gutter is in communication with the first pipe section. A second pipe section extends from the first pipe section and has a dispensing nozzle on the end thereof. The dispensing nozzle is disposed proximate to the gutter or roof. The first pipe section can be manipulated from the ground so that a user standing on the ground can deliver material through the assembly to the gutter or roof.

### CROSS-REFERENCE TO RELATED APPLICATION

The instant application claims priority to U.S. Provisional Patent Application Ser. No. 60/988,469, filed Nov. 16, 2007, the entire specification of which is expressly incorporated herein by reference.

### FIELD OF THE INVENTION

The present invention relates to a method and apparatus for maintaining rooftops, gutters or the like from ground level.

### DESCRIPTION OF THE RELATED ART

Often, gutters on residential and commercial buildings become blocked with debris, such as leaves, dirt, snow and/or ice. Typically, homeowners and commercial maintenance personnel must access the rooftop gutters by climbing ladders to maintain their gutters by manual cleaning, applying air or water to remove trapped debris, or applying salt or other chemicals for the purpose of melting ice or snow. This presents obvious hazards to individuals that must climb the ladders or scaffolds, particularly in inclement weather.

Most often, individuals cleaning gutters, in addition to the use of ladders, will build temporary scaffolding to climb on the rooftops to manually remove the debris or accumulated ice and snow. This method is an expensive operation and is difficult during inclement weather.

Alternatively, the debris, particularly snow and ice is removed by manually placing chemical ice melter onto the rooftop. However, this application is unreliable and not always effective, particularly in multi-level rooftop applications.

One other method of rooftop debris removal is the delivery of high-pressure water through standard water valves and hoses. These systems function fairly well for delivering water to clear debris, such as dirt or leaves. But, these systems lack any mechanism to apply other substances such as air, salt or other chemicals to the gutter.

Other devices for rooftop debris removal are shown in U.S. Pat. Nos. 5,746,027 and 4,252,183.

U.S. Pat. No. 5,746,027 shows a device having a flexible sleeve that is inflated to break apart the ice and cause it to flow off the rooftop.

U.S. Pat. No. 4,252,183 shows a device that is mounted onto the roof to provide a series of channel members. The channel members are made of a material absorbative of heat for purposes of melting accumulated ice or snow.

### SUMMARY OF THE INVENTION

According to one embodiment of the present invention, there is provided an apparatus for dispensing material to a gutter. The apparatus comprises a movement supply. A first pipe section is located in proximity to the ground. A receptacle is in communication with the first pipe section. A second pipe section is coupled with the first pipe section and extends upwardly therefrom. A nozzle is coupled with the second pipe section and is adapted for disposition at a position spaced from the ground.

According to another embodiment of the present invention, there is provided a method of dispensing material to a gutter comprising providing a movement supply. A first pipe section is provided which is located in proximity to the ground. A receptacle is provided in fluid communication with the first pipe section. A second pipe section is provided and is coupled with the first pipe section. The second pipe section extends upwardly from the first pipe section. A nozzle is provided that is coupled with the second pipe section. The nozzle is adapted for disposition at a position spaced from the ground. The movement supply is energized and material is moved from the receptacle through the first and the second pipe sections through the nozzle at a position spaced from the ground.

### BRIEF DESCRIPTION OF THE DRAWINGS

FIG. 1 is a schematic diagram of one embodiment of the present invention;

FIG. 2 is a schematic diagram of an alternate embodiment of the present invention;

FIG. 3 is a schematic diagram of an alternate embodiment of the present invention; and

FIG. 4 is a schematic view, partially exploded, showing various alternate embodiments of the present invention.

### DETAILED DESCRIPTION OF THE PREFERRED EMBODIMENT

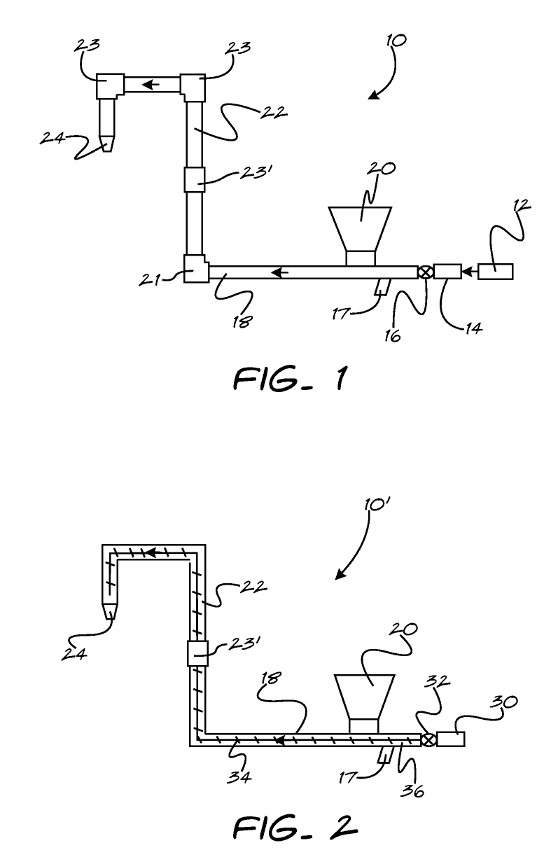

FIG. 1 schematically shows one embodiment of the present invention. More specifically, an apparatus for removing debris from a gutter is generally shown at 10. The apparatus 10 is intended to be connected to an air supply (not shown) via hookup or connector schematically represented at 12. The air supply is connected to the hookup 12 which is coupled to a line 14 that is coupled with an actuator 16. The actuator 16 preferably comprises a trigger valve.

The air supply preferably comprises an air compressor. The air supply provides the motivating force for moving chemicals through the apparatus 10 to a rooftop gutter (not shown). It will be appreciated that any suitable air compressor or air supply that provides sufficient air to the nozzle 24 may be used in accordance with the present invention.

The line 14 preferably comprises an air hose of the type typically used in pneumatic operations. Such air hoses may typically be flexible. Preferably, the line 14 may include a quick-connect coupling 12 of the type that is well-known. The quick-connect coupling 12 may be secured between the line 14 and the air supply.

It will be appreciated, that each of the air compressor, line 14, quick-connect adaptor, and trigger valve 16 may be of the type that are well-known. It will further be appreciated that any suitable air compressor, line, and trigger valve may be used within the context of the present invention. Additionally, while a trigger valve 16 is preferred, any suitable valve that selectively allows the flow of air may be used.

The trigger valve 16 is used to selectively control the flow of air through the apparatus 10. That is, the trigger valve 16 can be activated to an “on” position to allow the flow of air through the apparatus 10. The trigger valve 16 may preferably be biased to an “off” position that prevents the flow of air therepast. The trigger valve 16 may also be moved between various positions to selectively control the volume of air flowing through the apparatus 10.

An output side of the trigger valve 16 may be connected to a first pipe section 18. In the most preferred embodiment, the first pipe section 18 may comprise a rigid piping section. The piping can be constructed of commercially available rigid piping, such as plastic (for example, PVC) or metal pipes. The section 18 can be constructed by attaching together multiple pipe sections. The pipe section 18 can comprise several sections fixedly secured together such as by the use of glue, in the case of PVC piping, or threaded fittings in the case of metal piping. Alternatively, the pipe section 18 can comprise several sections connected together in a manner that can be released from one another. The first pipe section 18 can also be formed from a single piece. At least a portion of the first pipe section 18 is placed in proximity to the ground or near the ground. Being in proximity to the ground or near the ground means that the apparatus can be used by an operator on the ground without the need to use ladders, scaffoldings or other means to raise a user off of the ground. More particularly, the first pipe section can be moved and the valve 16 can be activated by a user on the ground. A handle or grip 12 may also be secured to the first pipe section 18.

A receptacle 20 may be provided and may be in communication with the interior of the first pipe section 18. The receptacle 20 may comprise a funnel-like receptacle that can be used to hold materials desired to be delivered to the gutter (not shown). For example, the receptacle 20 can hold salt or other ice melting material. As shown, the receptacle 20 may be mounted directly to the first pipe section 18 over top of the pipe section 18 such that the apparatus feeds by gravity. It will be appreciated that other methods of delivering the salt or other desired materials to the gutter may be used within the context of the present invention. For example, a tube (not shown) from the trigger valve 16 may be attached to a plastic pipe on one end, and a receptacle on the other. When the trigger valve 16 is actuated, the air creates a vacuum drawing the salt or other material into the first pipe section 18.

Preferably, there is a mechanism (not shown) in FIG. 1 to close off the communication between the receptacle 20 and the first pipe section 18. That is, it may be desirable to provide a mechanism that can selectively close off communication between the receptacle 20 and the first pipe section 18 such that if only air is desired to be delivered to the gutter, the receptacle 20 will not provide a port for allowing air to escape the apparatus 10. Preferably, the mechanism to close off the communication between the receptacle 20 and the first pipe section 18 comprises an on-off valve (not shown). Any suitable valve may be used.

A second pipe section 22 may be coupled with the first pipe section 18. The second pipe section 22 can take any suitable configuration. The second pipe section 22 may comprise an adjustable rigid piping system for delivery of material to the gutter. The second pipe section 22 may be made of multiple pipe sections coupled together. The second pipe section 22 can comprise plastic piping, such as, for example, PVC piping or metal piping. Preferably, the pipe sections are releasably coupled. That is, they can be secured for operation and removed for storage, or to adjust the configuration of the second pipe section.

The second pipe section 22 may be connected to the first pipe section by a suitable connector 21. For example, the suitable connector 21 may comprise an elbow. Further, the second pipe section 22 may have any number of angles (not shown) or elbows 23 or connections 25 in order to adjust the second pipe section 22 to allow the material to flow from the first pipe section 18 to the gutter. The second pipe section 22 is preferably adjustable to allow the shape of the second pipe section 22 to be adaptable for use in connection with varying application requirements. Also, the vertical portion of the second pipe section 22 may be configured in any manner. It may be angled to allow it to have a shape that advantageously gives an operator leverage when using the apparatus 10. Further, in each embodiment described herein, a handle (not shown) of the type of handle 17 may be used on the second pipe section 22.

A dispensing nozzle 24 may be attached at the end of the second pipe section 22. Any suitable dispensing nozzle 24 may be used in accordance with the present invention. The dispensing nozzle 24 may be configured to spray a fan pattern of the air into the gutter. Typical dispensing nozzles 24 will allow for coverage of 1 in. to 12 in. width which will accommodate most residential and commercial gutters. Further, it is preferred that the dispensing nozzles 24 be interchangeable. That is, the dispensing nozzles 24 can easily be changed to allow for different fluids passing through the pipes or different material to be dispensed to the gutter or different spray patterns. Any suitable means for allowing interchangeability of the dispensing nozzles 24 may be used. By way of non-limiting example, the dispensing nozzles 24 may be threaded onto the end of the second pipe section 22. Alternatively, the second pipe section 22 and nozzle may include quick connect features (not shown) as are known, to allow the nozzles 24 to be quickly removed and replaced from the second pipe section 22.

Use of the apparatus 10 is as follows. The first pipe section 18 and second pipe section 22 are configured to allow the dispensing nozzle 24 to be placed at an elevation over the gutter. Most preferably, the second pipe section 22 is configured to allow the dispensing nozzle 24 to be positioned over the gutter while the first pipe section 18 is located near the ground. The air compressor is coupled to the line 14 via connection 12. The line 14 is coupled to the trigger valve 16. The material to be delivered to the gutter is placed in the receptacle 20. The on-off valve (not shown) in FIG. 1 used to close off the receptacle 20 from the first pipe section 18 is opened such that it allows the material in the receptacle 20 to flow by gravity into the first pipe section 18. The trigger valve 16 is then actuated allowing air from the compressor to be moved through the first pipe section 18 and second pipe section 22 in the direction of the arrows and through the dispensing nozzle 24 and into the gutter or onto the roof. The air carries the material to be dispensed into the gutter, such as salt or other ice melting material. The dispensing nozzle 24 preferably is adjustable so that a pattern can be used to dispense the material over the entire width of the gutter or over a portion of the roof. Because the pipe sections 18, 22 are preferably light in weight and maneuverable, the pipe sections 18, 22 can be moved during use to allow the dispensing nozzle 24 to be moved over the entire length of the gutter. It will be appreciated that since the line 14 preferably comprises a flexible air hose, this allows the remainder of the apparatus 10 to easily be moved by the operator without the need to move the compressor. Flow of air and the material to be dispensed to the gutter can be stopped by deactivating the trigger valve 16.

In certain applications, it is not necessary that the valve between the receptacle 20 and the first pipe section 18 be opened. In such a case, only air will be delivered through the dispensing nozzle 24 to the roof. This may be used, for example, to clean debris, such as dirt or leaves from the gutter.

It will be appreciated that the system described is described in connection with using air as the motivating force. It will also be appreciated that in addition to or instead of an air compressor, a water source may be coupled with the first pipe section 18 via a suitable connector line. Such an arrangement is shown schematically in FIG. 3. Like numbers will be used to identify similar parts throughout the embodiments. This embodiment includes each of the features described above and additionally a water source. As shown in FIG. 3, the apparatus 10 includes a water line 40 is coupled to a suitable valve 42. The valve 42 is in fluid communication with the first pipe section 18. The valve 42 is moveable between an on position to allow water to flow from the line 40 into the first pipe section 18 and an off position which prevents water flow from the water line 40 into the first pipe section 18.

In this embodiment, water and air and can be delivered to the gutter through the pipe sections 18, 22 and dispensing nozzle 24. This, in essence, creates a high pressure water spray. Further, other materials, such as salt or cleaning chemicals, may be placed in the receptacle 20 that can be delivered to the gutter by using the water and air system. It will be appreciated that in the apparatus 10 air or water may be used together or individually to provide the motivating force for fluid flow through the apparatus 10. Accordingly, the movement supply may include a water supply, an air supply, or a combination thereof.

The water line 40 may be of any type. By way of non-limiting example, the water line can comprise a garden hose that is connected at one end to a water supply (not shown). Alternatively, the water line can comprise a high pressure water line that is connected to a high pressure water supply, such as a pressure washer. Further, valve 42 may comprise any suitable valve. By way of non-limiting example, the valve may comprise an on-off valve such as a globe valve. Alternatively, the valve 42 may comprise a trigger valve. The trigger valve 42 is used to selectively control the flow of water through the apparatus 10. That is, the trigger valve 42 can be activated to an “on” position to allow the flow of water through the apparatus 10. The trigger valve 42 may preferably be biased to an “off” position that prevents the flow of water therepast. The trigger valve 42 may also be moved between various positions to selectively control the volume of water flowing through the apparatus 10. It will be appreciated that any suitable water line 40 and valve 42 may be used within the context of the present invention.

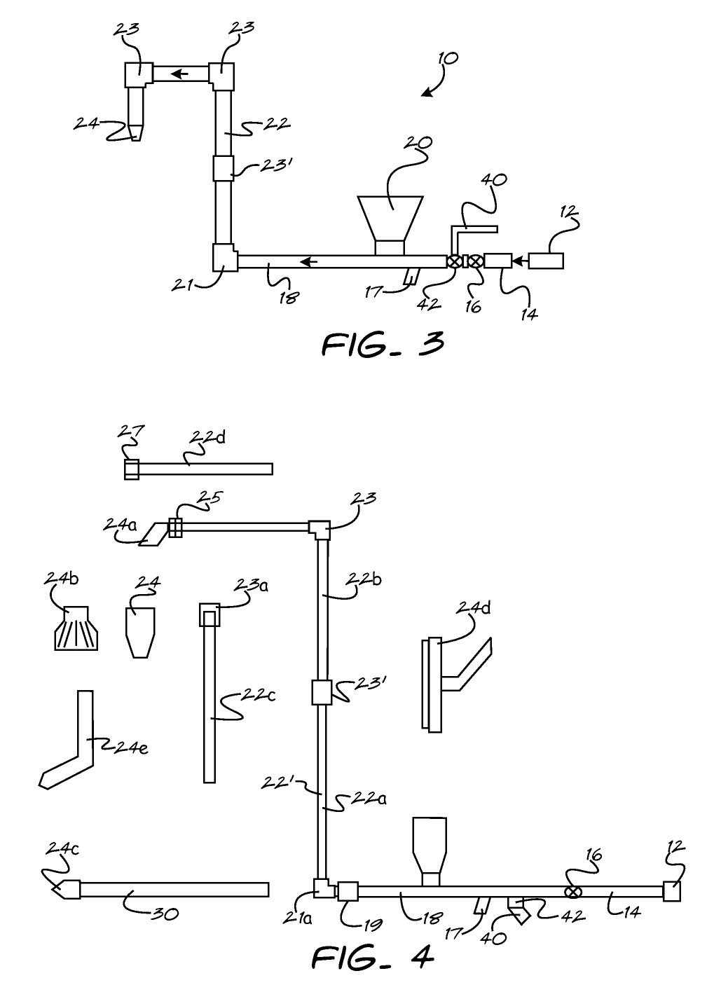

FIG. 2 shows another alternate embodiment of the present invention. Like numbers will be used to identify similar parts throughout the embodiments. In the alternate embodiment of FIG. 2, an apparatus 10′ is shown schematically. The apparatus includes a movement supply comprising a suitable motor, such as a drill motor 30. The drill motor 30 may comprise either a standard AC or DC drill motor. It is most preferred that the drill motor comprise a DC motor capable of operation with batteries. The drill motor 30 includes a trigger actuator 32. The drill motor 30 includes a standard key or keyless chuck. It will be appreciated that any suitable motor may be used.

The first pipe section 18 includes a conveyor 34. Preferably, the conveyor 34 comprises a screw conveyor including an end 36 that may be received in the chuck of the drill motor 30. A funnel-like receptacle 20 of the type disclosed above is in communication with the interior of the first pipe section 18, as set forth in connection with the embodiment described above.

Similarly, second pipe section 22 and dispensing nozzle 24 are as set forth in connection with the embodiments described above. The conveyor 34 is also disposed in the second pipe section 22. The conveyor 34 may be required to comprise various sections that co-act, in a known manner, to allow for bends or the like.

The screw conveyor 34 moves the material to be dispensed to the gutter, such as, for example, salt or other ice melting material, through the first pipe section 18. The material to be dispensed to the gutter then exits into the second pipe section 22 and is pushed by the screw conveyor 34 through the dispensing nozzle 24 and into the gutter. Thus, the drill motor rotates causing rotation of the screw conveyor 34 which pushes the material to be dispensed such as salt through the first pipe section 18 and the second pipe section 22 and out the dispensing nozzle 24.

Use of the apparatus 10′ is as follows. The first pipe section 18 and second pipe section 22 are configured to allow the dispensing nozzle 24 to be placed at an elevation over the gutter. Most preferably, the second pipe section 22 is configured to allow the dispensing nozzle 24 to be positioned over the gutter or roof section while the first pipe section 18 is located near the ground. The drill motor 30 is connected to end 36 of the screw conveyor 34. The material to be delivered to the gutter is placed in the receptacle 20. Any mechanism used to close off the receptacle 20 from the first pipe section 18 is open such that it allows the material in the receptacle 20 to flow by gravity into the first pipe section 18. The trigger actuator 32 of the drill motor 30 is then depressed causing the drill motor to rotate. This movement in turn causes the screw conveyor 34 to rotate. Rotation of the screw conveyor causes movement of the material to be delivered to the gutter to move in the direction of the arrows shown in FIG. 2. Continued movement of the material through the first pipe section 18 and the second pipe section 22 forces the material to be dispensed into the gutter through the dispensing nozzle 24.

Because the pipe sections 18, 22 are preferably light in weight and maneuverable, the pipe sections 18, 22 can be moved during use to allow the dispensing nozzle 24 to be moved over the entire length of the gutter. Flow of the material to be dispensed to the gutter can be stopped by deactivating the trigger actuator 32 on the drill motor 30.

FIG. 4 shows a schematic view, partially exploded, showing various alternate arrangements of the present invention.

FIG. 4 shows several of the same components identified in the embodiments above. Accordingly, like numbers will be used to identify like components throughout the various embodiments. As shown in FIG. 4, there may be an air hookup or connector 12 coupled with line 14. Line 14 is coupled to air flow valve 16. Air flow valve 16 is coupled with a first pipe section 18.

A water line 40 may be coupled to the first pipe section 18 via a valve 42. A receptacle, or dispensing funnel 20, may also be coupled to the first pipe section 18 via valve 21. The first pipe section 18 terminates at coupling 19.

A second pipe section generally indicated at 22′ is coupled with the first pipe section 18 at the coupling 19. The second pipe section 22′ comprises multiple pipe segments 22a, 22b. The pipe segment 22a is coupled to the first pipe section 18 via the coupling 19. The pipe segment 22a may include an elbow 21a. The pipe segment 22a may terminate at a coupling 23′. Another pipe segment 22b may be coupled to the segment 22a via a coupling 23′. Preferably, the second pipe segment 22b includes an elbow or 90° angle 23. The pipe segment 22b may terminate at a coupling 25.

Intermediate pipe segments 22c may be added between the pipe segments 22a and 22b. Specifically, a pipe segment 22c may be connected via a coupling 23′ to the pipe segment 22a. The intermediate pipe segment 22c includes another coupling 23a at one end thereof. The pipe segment 22b may then be connected to the intermediate pipe segment 22c via the coupling 23a. It will be appreciated that any number of intermediate pipe segments 22c may be used within the context of the present invention. Furthermore, coupling 23′ may comprise a straight coupling or may be angled in any manner. The use of one or more intermediate pipe segments 22c allows one to reach different heights spaced from the ground.

A terminal segment 22d may also be added the end of the second segment 22b. The terminal section 22d may be used to extend the horizontal reach of the assembly. The terminal section 22d may include a coupling 27 on the end thereof.

The coupling 25 on the segment 22b or the coupling 27 on the segment 22d may also be used to connect the pipe section 22 with any of a various interchangeable nozzles or tips 24a-24e. Several alternative nozzles are shown. Nozzle 24a is a standard nozzle for delivering air, water, material or a combination of these to the gutter or roof top. Nozzle 24b is a fan nozzle for dispensing air, water, material or a combination in a fan pattern to gutters and downspouts. Nozzle 24c is a tip for a high-pressure spray. Nozzle 24d is a nozzle that may include a brush for delivering material and for washing and/or scrubbing high areas that are out of reach. Nozzle 24e is an angled nozzle for delivering material at a different angle.

Also shown in FIG. 4 is an alternate arrangement where the upper pipe segment 22 is replaced with a high-pressure connection. That is, a pipe section 30 is coupled to the first pipe section 18 at the coupling 19. A high-pressure tip 24c is placed on the end of the pipe segment 30. In this manner, the assembly can be used to deliver material to items near the ground, such as for use as a high-pressure washer.

By allowing the interchangeability of nozzles and pipe segments, the apparatus has increased versatility. While the high-pressure tip 24c is shown on the pipe segment 30, it will be appreciated that any of the nozzles 24a-24e may be used on pipe segment 30.

It will be appreciated that, while in some embodiments, salt may be placed in the receptacle 20, any material may be placed in the receptacle within the context of the present invention. For example, for cleaning windows or other surfaces, the dispenser 20 may include soap or other cleaning materials. Further, while the embodiments are often discussed as delivery material to a gutter or roof top, the embodiments may also be configured to deliver material to areas located a distance, or spaced, from the ground, such as a side of a building or house that are otherwise accessible only by ladder, scaffolding or the like.

The invention has been described in an illustrative manner. It is to be understood that the terminology used is intended to be in the nature of words of description. Obviously many modifications and variations are possible in light of the above teachings. It is therefor to be understood that within the scope of the appended claims, the invention may be practiced other than as specifically described.

What is claimed is:

1. An apparatus for dispensing material to gutter comprising:
a movement supply;
a first pipe section located in proximity to the ground;
a receptacle in communication with said first pipe section;
a second pipe section coupled with said first pipe section and extending upwardly therefrom; and
a nozzle coupled with said second pipe section adapted for disposition at a position spaced from the ground.

2. An apparatus as set forth in claim 1 wherein said movement supply comprises an air supply coupled with the first pipe section via a valve.

3. An apparatus as set forth in claim 2 wherein said air supply comprises an air compressor.

4. An apparatus as set forth in claim 1 wherein said movement supply comprises a pressurized water supply coupled with the first pipe section via a valve.

5. An apparatus as set forth in claim 4 wherein said pressurized water supply comprises a pressure washer.

6. An apparatus as set forth in claim 1 wherein said movement supply comprises a drill motor.

7. An apparatus as set forth in claim 6 further comprising a conveyor disposed in said first pipe section and coupled with said drill motor.

8. An apparatus as set forth in claim 1 wherein said second pipe segment is adjustable.

9. A method of dispensing material to a gutter comprising:
providing a movement supply;
providing a first pipe section located in proximity to the ground;
providing a receptacle in communication with the first pipe section;
providing a second pipe section coupled with said first pipe section and extending upwardly thereform;
providing a nozzle coupled with said second pipe section adapted for disposition to a position spaced from the ground;
energizing the movement supply; and
moving material from said receptacle through said first and said second pipe sections through said nozzle to a position spaced from the ground.
